(19) United States
(12) Patent Application Publication
(10) Pub. No.: US 2017/0102560 A1
(43) Pub. Date: Apr. 13, 2017

(54) HEARING AID HOLDER FOR USE WITH EYEWEAR

(71) Applicant: James V. Murphy, North Kingston, RI (US)

(72) Inventor: James V. Murphy, North Kingston, RI (US)

(21) Appl. No.: 15/292,248

(22) Filed: Oct. 13, 2016

Related U.S. Application Data
(60) Provisional application No. 62/240,707, filed on Oct. 13, 2015.

(51) Int. Cl. G02C 11/06; H04R 25/00

(52) U.S. Cl. CPC G02C 11/06; H04R 25/60; H04R 25/65; H04R 2225/021

(57) ABSTRACT

An apparatus for use with eyewear and a hearing aid, comprises a sleeve having a first open end, a second open end and a first length of an elastomeric material between the first open end and the second open end, the length of the material being commensurate with a second length of the housing of the hearing aid; the sleeve sized and configured to receive the housing of the hearing aid through one of the first open end and the second open end and the at least one temple of the eyewear. The eyewear is of the type that has a lens frame and at least one temple connected to the lens. The hearing aid is of the type that has an earphone connected to a housing for enclosing circuitry for powering the earphone and for processing electrical signals from the earphone.

### CROSS REFERENCE TO RELATED APPLICATION

This application claims the benefit of the filing date of U.S. Provisional Application No. 62/240,707, filed on Oct. 13, 2015, the contents of which are hereby incorporated by reference in its entirety.

### BACKGROUND

This invention relates to hearing aid devices and eyewear.

The number of people using hearing aids as well as the price of hearing aids continues to rise. Most hearing aids today are made up of digital signal processors and although in other areas of consumer electronics, the use of digital technology has reduced the price of production costs, statistics have shown that in the last decade the price of an average Behind the Ear (BTE) hearing aid has more than doubled.

Hearing aids have also become smaller and lighter weight making them more comfortable to users and physically less noticeable to others. However, the smaller size and lower weight of hearing aids also makes them much more susceptible to loss. When a hearing aid falls off, or is otherwise separated from the wearer, that wearer may not even notice that the hearing aid is gone.

SUMMARY

The invention relates to an apparatus for use with eyewear and a hearing aid, the eyewear having a lens frame and at least one temple connected to the lens, while the hearing aid has an earphone connected to a housing for enclosing circuitry for powering the earphone and for processing electrical signals from the earphone.

In a general aspect of the invention, the apparatus comprises a sleeve having a first open end, a second open end and a first length of an elastomeric material between the first open end and the second open end, the length of the material being commensurate with a second length of the housing of the hearing aid. The sleeve is sized and configured to receive the housing of the hearing aid through one of the first open end and the second open end and the at least one temple of the eyewear.

Embodiments of this aspect of the invention may include one or more of the following features. The elastomeric material is a polyurethane-based material. The first open end is larger than the second open end. The sleeve tapers from the first open end to the second open end. The sleeve has a cylindrical tube shape. In certain embodiments, the cylindrical tube shape is seamless. In other embodiments, the cylindrical tube shape is in the form of a sheet having two edges which are attached to each other, for example, with stitching or an adhesive.

Among other advantages, the hearing aid holder serves to secure the hearing aid to an eyeglass frame thereby minimizing the risk of losing the hearing aid, which due to its small size and weight could be easily separated from the wearer. Furthermore, for users of hearing aids that also wear glasses, the hearing aid holder secures the hearing aid at a position of the eyeglass frame where the earphone portion of the hearing aid is conveniently located to where it is to be inserted within the wearer's ear.

Other features and advantages of the invention are apparent from the following description, and from the claims.

### DESCRIPTION OF DRAWINGS

FIG. 1 illustrates use of a hearing aid holder worn by a user wearing glasses.

FIG. 2 is an enlarged portion of the hearing aid holder shown in FIG. 1.

FIG. 3 is a side view of the hearing aid holder of FIG. 1 supporting a hearing aid and attached to an eyeglass frame.

FIG. 4 is a perspective view of one embodiment of a hearing aid holder.

FIG. 5 is a perspective view of another embodiment of a hearing aid holder.

FIG. 6 is a side view of another embodiment of a hearing aid holder.

### DETAILED DESCRIPTION

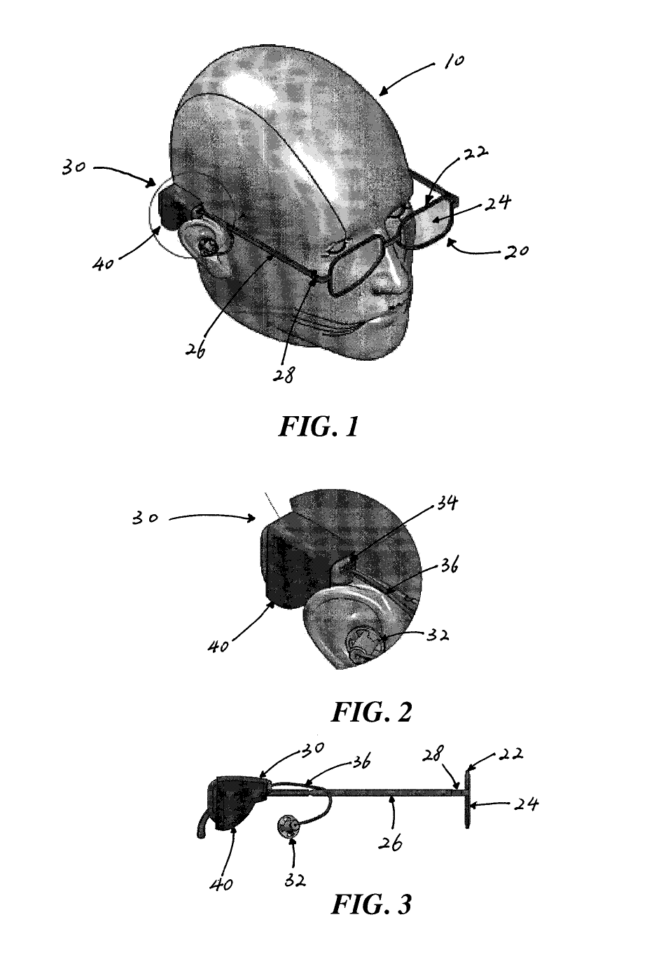

Referring to FIGS. 1-3, a person 10 who wears a pair of eyeglasses 20 and also uses a hearing aid 30 is shown using a hearing aid holder 40 that receives the hearing aid 30 and also couples the hearing aid to the pair of eyeglasses. The eyeglasses 20 are of the type having a frame 22 that holds lenses 24 and a pair of temples 26 that are joined to the frame, typically with hinges 28.

The hearing aid 30 is of the type, typically referred to as a Behind the Ear (BTE) hearing aid in which an earphone 32 is connected to a housing 34 via a connecting tube wire 36. Housing 34 encloses a battery (not shown) for powering the earphone as well as circuitry (not shown) in the housing for processing electrical signals received by the earphone. Connecting wire 36 includes an electrical conductor covered by an insulative jacket such that the connecting wire can be bent to allow the earphone to be substantially fixed relative to housing 34 and such that the earphone is already in a position for being easily inserted in the ear by simply pushing the earphone in a direction toward the opening of the ear.

Hearing aid holder 40 is formed of an elastomeric material, such as a lightweight, synthetic fiber. For example, the elastomeric material can be polyurethane-based material that can be stretched to a certain degree and will return almost exactly back to its original size and shape. Additionally, the material is lightweight, relatively soft, smooth and easily dyed. The material is also resilient since it is resistant to abrasion and the deleterious effects of body oils, perspiration, and detergents. They are compatible with other materials, and can be spun with other types of fibers to produce unique fabrics, which have characteristics of both fibers.

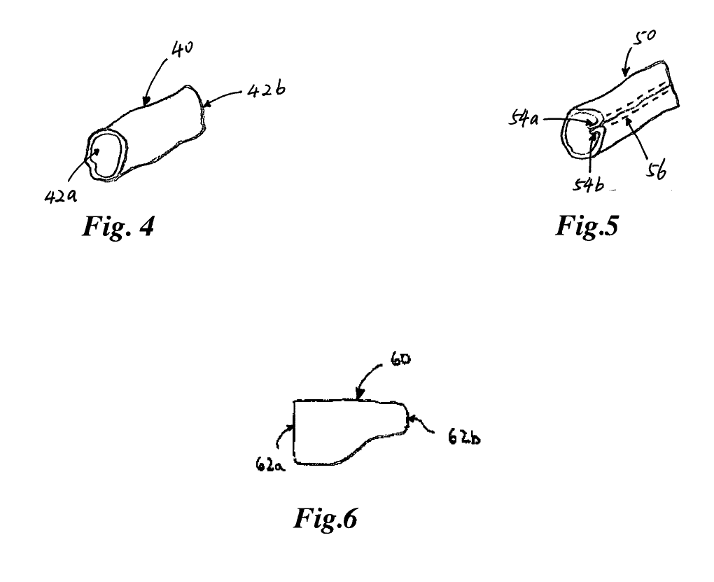

Referring to FIG. 4, hearing aid holder 40 is substantially cylindrical in shape and has a length that is substantially the length of hearing aid 30. Hearing aid holder 40 has openings 42a, 42b at each end of the holder. The size of openings 42a, 42b not only allow for the hearing aid to be received within hearing aid holder 40 but also allow for the eyeglass temple to extend through the hearing aid holder. In the embodiment shown in FIG. 3, hearing aid holder 40 has a seamless construction in which the holder is woven as a single tube.

Alternatively, as shown in FIG. 5, hearing aid holder 50 is manufactured from a sheet of elastomeric material with two edges 54a, 54b of the sheet attached to form a cylindrically shaped tube. In some embodiments, the sheet is stitched together using thread 56 while in other embodiments, the edges are attached with an adhesive.

Referring to FIG. 6, in certain embodiments, a sleeve 60 may have a tapered shape such that the opening at one end 62a is larger than the opening at the opposite end 62b. With this embodiment, the sleeve may more closely resemble the shape of the housing of the hearing aid itself; thus the hearing aid is better captured within the housing. Furthermore, the sleeve is generally dimensioned such that it is slightly smaller than the dimensions of the housing 34 of hearing aid 30. The elastic material will stretch and hold the hearing aid housing 34 in a snug and secure manner to eyeglass frame 26. The sleeve has one opening that is sufficiently large to receive the hearing aid housing. On the other hand, the opening at the opposite end of the sleeve is too small to receive the housing of the hearing aid but sufficiently large to allow the temple of the eyeglass frame to pass therethrough. Sleeve 60 is configured such that once the housing 34 of hearing aid 30 is properly secured in the sleeve pre-bent connecting wire 36 and earphone 32 are in a position such, with one simple motion, the earphone can be easily placed into the opening of the ear by pushing the earphones toward the wearer's head.

It is to be understood that the foregoing description is intended to illustrate and not to limit the scope of the invention, which is defined by the scope of the appended claims. Other embodiments are within the scope of the following claims.

What is claimed is:

1. An apparatus for use with eyewear and a hearing aid, the eyewear having a lens frame and at least one temple connected to the lens, the hearing aid having an earphone connected to a housing for enclosing circuitry for powering the earphone and for processing electrical signals from the earphone, the apparatus comprising:
a sleeve having a first open end, a second open end and a first length of an elastomeric material between the first open end and the second open end, the length of the material being commensurate with a second length of the housing of the hearing aid; the sleeve sized and configured to receive the housing of the hearing aid through one of the first open end and the second open end and the at least one temple of the eyewear.

2. The apparatus of claim 1 wherein the elastomeric material is a polyurethane-based material.

3. The apparatus of claim 1 wherein the first open end is larger than the second open end.

4. The apparatus of claim 1 wherein the sleeve tapers from the first open end to the second open end.

5. The apparatus of claim 1 wherein the sleeve has a cylindrical tube shape.

6. The apparatus of claim 5 wherein the cylindrical tube shape is seamless.

7. The apparatus of claim 5 wherein the cylindrical tube shape is in the form of a sheet having two edges which are attached to each other.

8. The apparatus of claim 7 further comprising stitching to attach the two edges.

9. The apparatus of claim 7 further comprising an adhesive to attach the two edges.
